(19) United States
(12) Patent Application Publication
(10) Pub. No.: US 2005/0090920 A1
(43) Pub. Date: Apr. 28, 2005

(54) Method for creating an improvement plan for increasing ease of vehicle disassembly

(76) Inventor: Won Bae Lee, Seoul (KR)

Correspondence Address: MORGAN, LEWIS & BOCKIUS, LLP., 2 PALO ALTO SQUARE, 3000 EL CAMINO REAL, PALO ALTO, CA, 94306, US

(21) Appl. No.: 10/747,894

(22) Filed: Dec. 29, 2003

(30) Foreign Application Priority Data
Oct. 24, 2003 (KR) 10-2003-0074751

(51) Int. Cl. G06F 19/00

(52) U.S. Cl. 700/97

(57) ABSTRACT

A method for creating an improvement plan for increasing ease of vehicle disassembly comprises determining a disassembly assessment index based on disassembly assessment data using a predetermined disassembly assessment table and determining a design improvement plan for increasing ease of disassembly based on the determined disassembly assessment index using a predetermined disassembly improvement plan table.

### CROSS-REFERENCE TO RELATED APPLICATIONS

This application claims priority to Korean Application No. 10-2003-0074751, filed Oct. 24, 2003, the disclosure of which is incorporated fully herein by reference.

### FIELD OF THE INVENTION

Generally, the present invention relates to disassembly and recycling of a vehicle. More particularly, to methods for creating a plan for improving and increasing the ease of disassembly of the vehicle.

### BACKGROUND OF THE INVENTION

Environmental pollution due to retired cars has become a serious problem. Therefore, scrapping of the retired cars in an environmentally friendly way is required. Regulations in various countries have been changed to enforce car manufacturing companies to recover retired cars that they have produced. In order to strengthen their competitiveness, the car manufacturing companies must, therefore, manufacture cars that can be easily disassembled.

Therefore, in order to decrease disassembly costs of the retired cars, technologies for easy disassembly and recycling must be applied in a developing stage of a new car. However, there has been no way to provide guidelines for assessing ease of disassembly of a car and for re-designing a car to improve ease of disassembly.

The information disclosed in this Background of the Invention section is only for enhancement of understanding of the background of the invention and should not be taken as an acknowledgement or any form of suggestion that this information forms the prior art that is known to a person skilled in the art.

### SUMMARY OF THE INVENTION

An embodiment of the present invention provides a method for creating an improvement design plan for increasing ease of vehicle disassembly using various disassembly assessment data.

In a preferred embodiment the method: determining a disassembly assessment index based on disassembly assessment data using a predetermined disassembly assessment table and determining a design improvement plan for increasing ease of disassembly based on the determined disassembly assessment index using a predetermined disassembly improvement plan table.

It is preferable that the disassembly assessment data structure comprises disassembly assessment data that are data for assessing ease of disassembly of structures of a vehicle and component disassembly assessment data that are data for assessing ease of disassembly of individual components of each structure of the vehicle.

It is further preferable that the structure disassembly assessment data comprise accessibility data that has information on ease of approaching a coupling element of a corresponding structure. Also, disassembly force transmissibility data that has information on ease of transmitting disassembling force to the coupling element of the corresponding structure and disassembly structural attribute data that has information on the coupling element itself of the corresponding structure.

It is still further preferable that the structure disassembly assessment data comprises at least one of approaching direction change number data that indicate a number of changes of an approaching direction to the coupling element of the corresponding structure needed, approaching space size data that indicate ease of approaching coupling elements of the corresponding structure, approaching route visibility data that indicate a degree of visual exposure of an approaching route to the coupling element of the corresponding structure, and self location data that indicate whether a guide guiding to the coupling element of the corresponding structure exists.

It is preferable that the determining a disassembly assessment index determines the disassembly assessment index by endowing weights in a sequence of the approaching space size data, the approaching route visibility data, the approaching direction change number data, and the self location data.

It is preferable that the disassembly force transmissibility data among the structure disassembly assessment data comprises at least one of visibility data that indicate a degree of visual exposure of the coupling element of the corresponding structure, working space size data that indicate a size of a working space in which an operation to disassemble the coupling element of the corresponding structure is performed, disassembling force data that indicate an amplitude of a required disassembling force for disassembling the coupling element of the corresponding structure, and holding ease data that indicate an ease of holding the coupling element of the corresponding structure.

It is further preferable that the determining a disassembly assessment index determines the disassembly assessment index by endowing weights in a sequence of the visibility data, the disassembling force data, the working space size data, and the holding ease data.

It is preferable that the disassembly structural attribute data among the structure disassembly assessment data comprises pre-disjoint component number data that indicate a number of components that must be removed in order to extract the coupling element of the corresponding structure, disposition state data that indicate a degree of interference of neighboring structures or components for extracting the coupling element of the corresponding structure, coupling element number data that indicate a number of coupling elements of the corresponding structure, connected component number data that indicate a number of structures or individual components that are connected to the corresponding structure, and coupling point number data that data indicate a number of coupling points of the corresponding structure.

It is further preferable that the determining a disassembly assessment index determines is the disassembly assessment index by endowing weights in a sequence of the disposition state data, the pre-disjoint component number data, the coupling point number data, the connected component number data, and the coupling element number data.

It is preferable that the component disassembly assessment data comprise accessibility data that has information on ease of approaching a coupling element of a corresponding component, disassembly force transmissibility data that has information on ease of transmitting disassembling force to the coupling element of the corresponding component, and disassembly structural attribute data that has information on the coupling element itself of the corresponding component.

It is further preferable the accessibility data of the component disassembly assessment data comprise at least one of disposition state data that indicate a degree of stability of disposition of the corresponding component, approaching direction change number data that indicate a number of changes of direction of approach to the coupling element of the corresponding component, coupling portion exposure data that indicate a degree of interference by other components while approaching the corresponding component coupling portion, and state maintenance data that data indicate interference by other components and a necessity of state maintenance of the other components while approaching the coupling element of the corresponding component.

It is still further preferable that the determining a disassembly assessment index determines the disassembly assessment index by endowing weights in a sequence of the coupling portion exposure data, the approaching direction change number data, the state maintenance data, and the disposition state data among the accessibility data.

It is preferable that the disassembly force transmissibility data among the component disassembly assessment data comprise at least one of fixing state data that indicate a necessity of holding the corresponding component while disassembling the corresponding component, working space size data that indicate a size of a working space in which an operation to disassemble the coupling element of the corresponding component is performed, disassembling force data that indicate an amplitude of a required disassembling force for disassembling the coupling element of the corresponding component, and holding ease data that indicate ease of holding the coupling element of the corresponding component.

It is further preferable that the determining a disassembly assessment index determines the disassembly assessment index by endowing weights in a sequence of the fixing state data, the disassembling force data, the working space size data, and the holding ease data.

It is preferable that the disassembly structural attribute data among the structure disassembly assessment data comprise pre-disjoint component number data that indicate a number of components that must be previously removed in order to disassemble the coupling element of the corresponding component, disposition state data that indicate a degree of interference of neighboring structures or components for disassembling the coupling element of the corresponding component, coupling element number data that indicate a number of coupling elements of the corresponding component, connected component number data that indicate a number of structures or components that are connected to the corresponding component, and coupling point number data that indicate a number of coupling points of the corresponding component.

It is further preferable that the determining a disassembly assessment index determines the disassembly assessment index by endowing weights in a sequence of the disposition state data, the pre-disjoint component number data, the coupling point number data, the coupling element number data, and the connected component number data.

### BRIEF DESCRIPTION OF THE DRAWINGS

The accompanying drawings, which are incorporated in and constitute a part of the specification, illustrate an embodiment of the invention, and, read together with the description, serve to explain the principles of the invention, where:

FIG. 1 is a flowchart of the method for creating an improvement plan for increasing ease of vehicle disassembly according to an embodiment of the present invention;

FIG. 2 shows a checklist of structure disassembly assessment data for a method according to an embodiment of the present invention; and

FIG. 3 shows a checklist of component disassembly assessment data for a method according to an embodiment of the present invention.

### DETAILED DESCRIPTION OF PREFERRED EMBODIMENTS

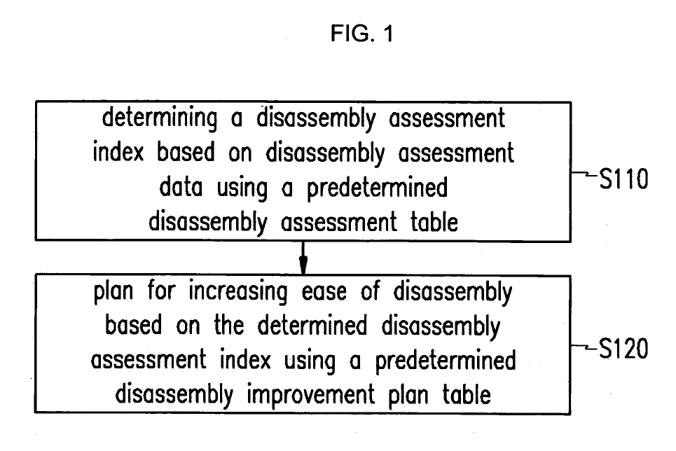

As shown in FIG. 1, the methods for creating an improvement plan for increasing ease of vehicle disassembly comprises a step S110 of determining a disassembly assessment index based on disassembly assessment data using a predetermined disassembly assessment table. Step S120 determines a design improvement plan for increasing ease of disassembly based on the determined disassembly assessment index using a predetermined disassembly improvement plan table. The disassembly assessment data includes structure disassembly assessment data that are data for assessing ease of disassembly of structures (or assemblies) of a vehicle and component disassembly assessment data that are data for assessing ease of disassembly of individual components (or parts) of each structure of the vehicle.

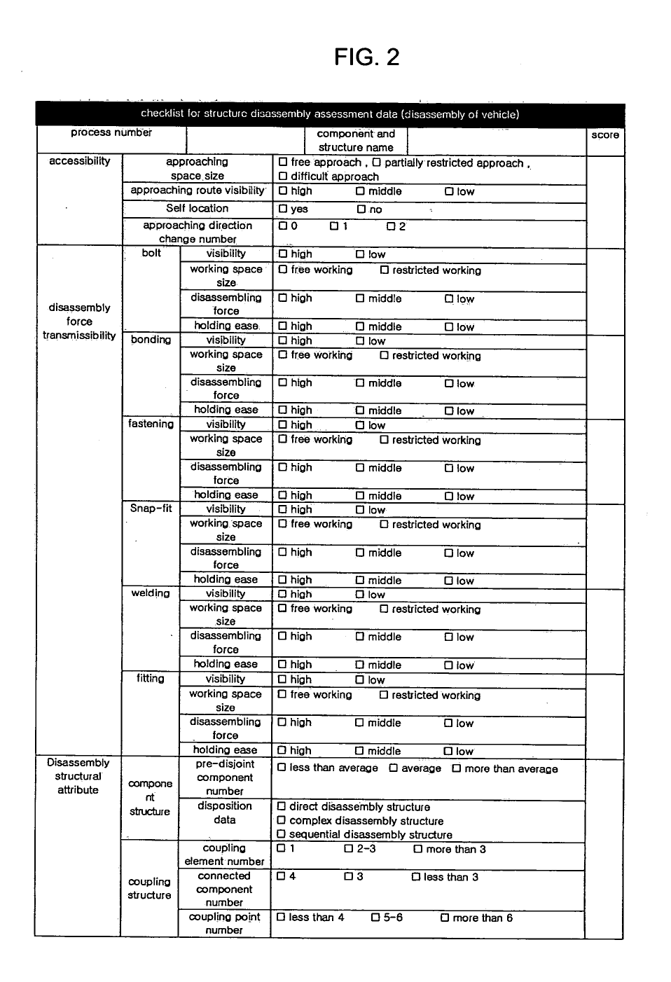

FIG. 2 shows a checklist for acquiring the structure disassembly assessment data. As shown in FIG. 2, the structure disassembly assessment data includes accessibility data that has information on ease of approaching a coupling element of a corresponding structure. The data also includes disassembly force transmissibility data that has information on ease of transmitting disassembling force to the coupling element of the corresponding structure and disassembly structural attribute data that has information on the coupling element itself of the corresponding structure.

The accessibility data of the structure disassembly assessment data preferably includes at least one of approaching direction change number data, approaching space size data, approaching route visibility data, and self location data.

In determining the disassembly assessment index in step S110, weights are preferably endowed in a sequence of the approaching space size data, the approaching route visibility data, the approaching direction change number data, and the self location data. That is, the disassembly assessment index is affected the greatest by the approaching space size data among the accessibility data, because the accessibility to the corresponding structure can be considered as a most decisive factor.

The approaching space size data indicate ease of approaching coupling elements of the corresponding structure. As an example, the approaching space size data can indicate that an approach to the coupling elements of the corresponding structure is free, that an approach to the coupling elements of the corresponding structure in a specific direction is restricted, or that an approach to the coupling elements of the corresponding structure is difficult.

In the predetermined disassembly assessment table, a predetermined score is endowed to each of the approaching space size data levels. That is, a highest score is endowed for the data level indicating the free approach, a middle score is endowed for the data level indicating the restricted approach, and a lowest score is endowed for the data level indicating the difficult approach.

The approaching direction change number data indicate a number of changes of an approaching direction to the coupling element of the corresponding structure needed. As an example, the approaching direction change number data can indicate that the coupling element of the corresponding structure can be approached without a change of an approaching direction, that the coupling element can be approached after one change of the approaching direction, or that the coupling element can be approached after more than two changes of the approaching direction.

In the predetermined disassembly assessment table, a predetermined score is endowed to each of the approaching direction change number data levels.

The approaching route visibility data indicate a degree of visual exposure of an approaching route to the coupling element of the corresponding structure. As an example, the approaching route visibility data can indicate that the approaching route can be seen without motion of a worker, that the approaching route can only be seen with motion of a worker, or that another component must be removed before the approaching route is visible.

In the predetermined disassembly assessment table, a predetermined score is endowed to each of the approaching route visibility data levels.

The self location data indicate whether a guide such as a supporting member or a passage that guides to the coupling element of the corresponding structure exists. As an example, the self location data can indicate that the coupling element of the corresponding structure is not exposed and a guide to the same exists, or that the coupling element of the corresponding structure is not exposed and a guide to the same does not exist.

In the predetermined disassembly assessment table, a predetermined score is endowed to each of the self location data levels.

The disassembly force transmissibility data of the structure disassembly assessment data preferably includes at least one of visibility data, disassembling force data, working space size data, and holding ease data.

In determining the disassembly assessment index using the disassembly force transmissibility data in step S110, weights are preferably endowed in a sequence of the visibility data, the disassembling force data, the working space size data, and the holding ease data. That is, the disassembly assessment index is affected the most by the visibility data among the disassembly force transmissibility data, because the visibility data can be considered as a most decisive factor.

The visibility data indicate a degree of visual exposure of the coupling element of the corresponding structure. As an example, the visibility data can indicate that all of the coupling element of the corresponding structure is visually exposed while the coupling element is being disassembled, or that a portion of the coupling element of the corresponding structure is not visually exposed while the coupling element is being disassembled.

In the predetermined disassembly assessment table, a predetermined score is endowed to each of the visibility data levels.

The working space size data indicate a size of a working space in which an operation to disassemble the coupling element of the corresponding structure is performed. As an example, the working space size data can indicate that the working space is large enough to not disturb an action of a worker and a movement of a working tool, or that the working space is not large enough to not disturb an action of a worker and a movement of a working tool.

In the predetermined disassembly assessment table, a predetermined score is endowed to each of the working space size data levels.

The disassembling force data indicate an amplitude of a required disassembling force for disassembling the coupling element of the corresponding structure. As an example, the disassembling force data can indicate that the coupling element of the corresponding structure can be disassembled by hand or can easily be disassembled with one hand using a working tool, that the coupling element of the corresponding structure cannot be easily disassembled with one hand using the working tool but can be easily disassembled with both hands using the working tool, or that the coupling element of the corresponding structure can be disassembled with both hands using the working tool or the coupling elements are broken while it is being disassembled.

In the predetermined disassembly assessment table, a predetermined score is endowed to each of the disassembling force data levels.

The holding ease data indicate an ease of holding the coupling element of the corresponding structure. As an example, the holding ease data can indicate that the coupling element of the corresponding structure cannot be held with a worker's hand or a working tool for disassembling the same, that the coupling element of the corresponding structure cannot be easily held by the worker's hand or the working tool, or that the coupling element of the corresponding structure can be held by the worker's hand and the working too.

In the predetermined disassembly assessment table, a predetermined score is endowed to each of the holding ease data levels.

The disassembly structural attribute data among the structure disassembly assessment data preferably includes pre-disjoint component number data, disposition state data, coupling element number data, connected component number data, and coupling point number data.

In determining the disassembly assessment index using the disassembly structural attribute data in step S110, weights are preferably endowed in a sequence of the disposition state data, the pre-disjoint component number data, the coupling point number data, the connected component number data, and the coupling element number data. That is, the disassembly assessment index is affected the most by the disposition state data among the disassembly structural attribute data, because the disposition state data can be considered as a most decisive factor.

The pre-disjoint component number data indicate a number of components that must be removed in order to extract the coupling element of the corresponding structure.

The disposition state data indicate a degree of interference of neighboring structures or components for extracting the coupling element of the corresponding structure.

The coupling element number data indicate a number of coupling elements of the corresponding structure.

The connected component number data indicate a number of structures or individual components that are connected to the corresponding structure.

The coupling point number data indicate a number of coupling points of the corresponding structure.

In the predetermined disassembly assessment table, predetermined scores are endowed to each of the pre-disjoint component number data levels, the disposition state data levels, the coupling element number data levels, the connected component number data levels, and the coupling point number data levels.

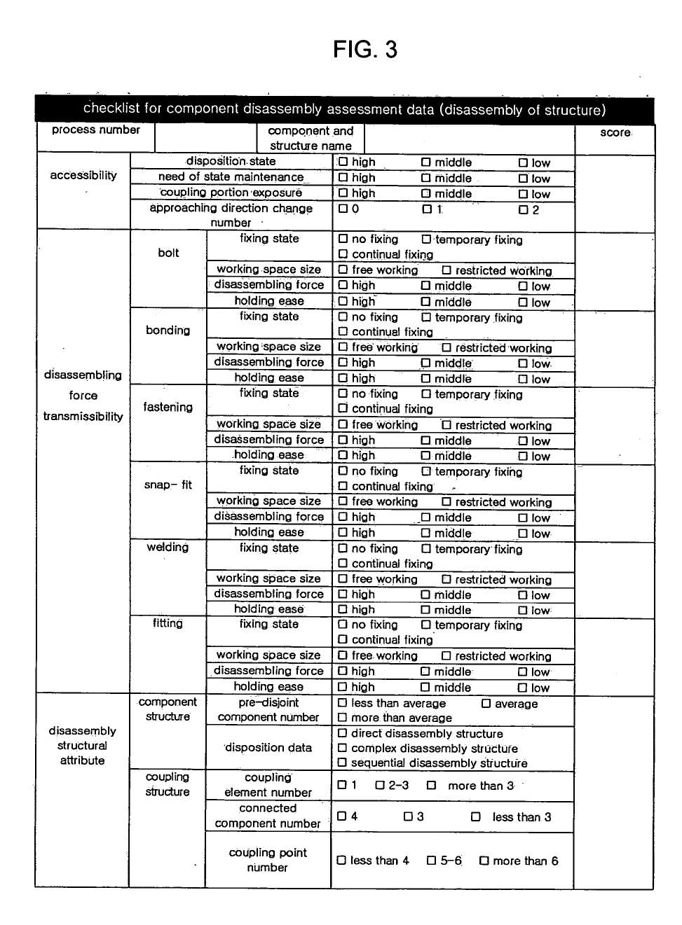

FIG. 3 shows a checklist for acquiring the component disassembly assessment data. As shown in FIG. 3, the component disassembly assessment data include accessibility data that has information on ease of approaching a coupling element of a corresponding component, disassembly force transmissibility data that has information on ease of transmitting disassembling force to the coupling element of the corresponding component, and disassembly structural attribute data that has information on the coupling element itself of the corresponding component.

The accessibility data of the component disassembly assessment data preferably include at least one of disposition state data, approaching direction change number data, coupling portion exposure data, and state maintenance data.

In determining the disassembly assessment index in step S110, weights are preferably endowed in a sequence of the coupling portion exposure data, the approaching direction change number data, the state maintenance data, and the disposition state data among the accessibility data. That is, the disassembly assessment index is affected the most by the coupling portion exposure data among the accessibility data.

The disposition state data indicate a degree of stability of disposition of the corresponding component. As an example, the disposition state data can indicate that the component must be held from at least two directions because of instability of disposition of the component, that the component must be held from one direction, or that the component does not need to be held.

In the predetermined disassembly assessment table, a predetermined score is endowed to each of the disposition state data levels.

The approaching direction change number data indicate a number of changes of direction of approach to the coupling element of the corresponding component. As an example, the approaching direction change number data can indicate that the coupling element of the corresponding component can be approached without a change of approaching direction, that the coupling element can be approached after one change of the approaching direction, or that the coupling element can be approached after two or more approaching direction changes.

In the predetermined disassembly assessment table, a predetermined score is endowed to each, of the approaching direction change number data levels.

The coupling portion exposure data indicate a degree of interference by other components while approaching the corresponding component coupling portion. As an example, the coupling portion exposure data can indicate that there is no interference by other components, that there is interference by other components, that the coupling element of the corresponding component is not exposed and there is a guide to guide to the coupling element of the corresponding component, or that there is interference by other components, the coupling element of the corresponding component is not exposed, and there is no guide to guide to the coupling element of the corresponding component.

In the predetermined disassembly assessment table, a predetermined score is endowed to each of the coupling portion exposure data levels.

The state maintenance data indicate interference by other components sand a necessity of state maintenance of the other components while approaching the coupling element of the corresponding component. As an example, the state maintenance data can indicate that there is interference by other components and state maintenance of the other components is necessary, that there is interference by other components but state maintenance of the other components is not necessary, or that there is no interference by the other components.

In the predetermined disassembly assessment table, a predetermined score is endowed to each of the state maintenance data levels.

The disassembly force transmissibility data among the component disassembly assessment data preferably includes at least one of fixing state data, working space size data, disassembling force data, and holding ease data.

In determining the disassembly assessment index using the disassembly force transmissibility data in step S110, weights are preferably endowed in a sequence of the fixing state data, the disassembling force data, the working space size data, and the holding ease data.

The fixing state data indicate a necessity of holding the corresponding component while disassembling the corresponding component. As an example, the fixing state data can be indicate that the corresponding component does not need to be held by instruments while disassembling the corresponding component, that the component does not need to be held in an early stage of disassembling of the component but the component needs to be held after removing some coupling elements of the corresponding component, or that the component needs to be held from an early stage of disassembling of the component.

In the predetermined disassembly assessment table, a predetermined score is endowed to each of the fixing state data levels.

The working space size data indicate a size of a working space in which an operation to disassemble the coupling element of the corresponding component is performed. As an example, the working space size data can indicate that the working space is wide enough to not disturb an action of a worker and a movement of a working tool, or that the working space is not wide enough to not disturb an action of a worker and a movement of a working tool.

In the predetermined disassembly assessment table, a predetermined score is endowed to each of the working space size data levels.

The disassembling force data indicate an amplitude of a required disassembling force for disassembling the coupling element of the corresponding component. As an example, the disassembling force data can indicate that the coupling element of the corresponding component can be disassembled by hand or can easily be disassembled with one hand using a working tool, that the coupling element of the corresponding component cannot be easily disassembled with one hand using the working tool and can be easily disassembled with both hands using the working tool, or that the coupling element of the corresponding component can be disassembled with both hands using the working tool or the coupling elements is broken while it is being disassembled.

In the predetermined disassembly assessment table, a predetermined score is endowed to each of the disassembling force data levels.

The holding ease data indicate ease of holding the coupling element of the corresponding component. As an example, the holding ease data can indicate that the coupling element of the corresponding component cannot be held with a worker's hand or a working tool for disassembling the same, that the coupling element of the corresponding component is not easily held with the worker's hand or the working tool, or that the coupling element of the corresponding component can be held with the worker's hand or the working tool.

In the predetermined disassembly assessment table, a predetermined score is endowed to each of the holding ease data levels.

The disassembly structural attribute data among the structure disassembly assessment data preferably includes pre-disjoint component number data, disposition state data, coupling element number data, connected component number data, and coupling point number data.

In determining the disassembly assessment index using the disassembly structural attribute data in step S110, weights are preferably endowed in a sequence of the disposition state data, the pre-disjoint component number data, the coupling point number data, the coupling element number data, and the connected component number data. That is, the disassembly assessment index is affected the most by the disposition state data among the disassembly structural attribute data, because the disposition state data can be considered as a most decisive factor.

The pre-disjoint component number data indicate a number of components that must be previously removed in order to disassemble the coupling element of the corresponding component.

The disposition state data indicate a degree of interference of neighboring structures or components for disassembling the coupling element of the corresponding component.

The coupling element number data indicate a number of coupling elements of the corresponding component.

The connected component number data indicate a number of structures or components that are connected to the corresponding component.

The coupling point number data indicate a number of coupling points of the corresponding component.

In the predetermined disassembly assessment table, predetermined scores are endowed to each of the re-disjoint component number data levels, the disposition state data levels, the coupling element number data levels, the connected component number data levels, and the coupling point number data levels.

The design improvement plans for each of the structures and components of a vehicle are determined based on the determined disassembly assessment index using the predetermined disassembly improvement plan table.

The method according to the embodiment of the present invention can be realized by a computer program including a plurality of input interfaces through which the disassembly assessment data can be input, and a plurality of output interfaces through which the disassembly assessment index and the design improvement plan are displayed.

The disassembly assessment index for each of the structures and components of the vehicle is determined based on disassembly assessment data that are input through various input windows using the predetermined disassembly assessment table. Preferably, the disassembly assessment index for each of specific structures and components can be scores of accessibility, disassembly force transmissibility, and disassembly structural attributes.

Furthermore, the design improvement plan for each of the structures and components is based on the determined disassembly assessment index and the predetermined design improvement plan table. Design guidelines regarding the accessibility, the disassembly force transmissibility, and the disassembly structural attribute can be displayed. At this time, an item that has the greatest room for improvement is determined as a basic design rule, and other items are determined as detailed design rules. Therefore, a user can acquire information on the design improvement plan for each of the structures and the components of the vehicle.

Although preferred embodiments of the present invention have been described in detail hereinabove, it should be clearly understood that many variations and/or modifications of the basic inventive concepts herein taught which may appear to those skilled in the present art will still fall within the spirit and scope of the present invention, as defined in the appended claims.

According the embodiment of the present invention, the disassembly assessment index is determined based on the disassembly assessment data, and the design improvement plan for increasing ease of vehicle disassembly is determined, so that information for improving the ease of disassembly of the vehicle can be provided.

In addition, the disassembly assessment data includes the structure disassembly assessment data and the component disassembly assessment data, so that the improvement plan can be acquired for each of the structures and components of the vehicle.

1. A method for creating an improvement plan for increasing ease of vehicle disassembly comprising:
determining a disassembly assessment index based on disassembly assessment data using a predetermined disassembly assessment table; and
determining a design improvement plan for increasing ease of disassembly based on the determined disassembly assessment index using a predetermined disassembly improvement plan table.

2. The method of claim 1, wherein the disassembly assessment data structure comprises disassembly assessment data that are data for assessing ease of disassembly of structures of a vehicle, and component disassembly assessment data that are data for assessing ease of disassembly of individual components of each structure of the vehicle.

3. The method of claim 2, wherein the structure disassembly assessment data comprise accessibility data that has information on ease of approaching a coupling element of a corresponding structure, disassembly force transmissibility data that has information on ease of transmitting disassembling force to the coupling element of the corresponding structure, and disassembly structural attribute data that has information on the coupling element itself of the corresponding structure.

4. The method of claim 3, wherein the structure disassembly assessment data comprises at least one of approaching direction change number data that indicate a number of changes of an approaching direction to the coupling element of the corresponding structure needed,
approaching space size data that indicate ease of approaching coupling elements of the corresponding structure,
approaching route visibility data that indicate a degree of visual exposure of an approaching route to the coupling element of the corresponding structure, and
self location data that indicate whether a guide guiding to the coupling element of the corresponding structure exists.

5. The method of claim 4, wherein the determining a disassembly assessment index determines the disassembly assessment index by endowing weights in a sequence of the approaching space size data, the approaching route visibility data, the approaching direction change number data, and the self location data.

6. The method of claim 3, wherein the disassembly force transmissibility data among the structure disassembly assessment data comprises at least one of
visibility data that indicate a degree of visual exposure of the coupling element of the corresponding structure,
working space size data that indicate a size of a working space in which an operation to disassemble the coupling element of the corresponding structure is performed,
disassembling force data that indicate an amplitude of a required disassembling force for disassembling the coupling element of the corresponding structure, and
holding ease data that indicate an ease of holding the coupling element of the corresponding structure.

7. The method of claim 6, wherein the determining a disassembly assessment index determines the disassembly assessment index by endowing weights in a sequence of the visibility data, the disassembling force data, the working space size data, and the holding ease data.

8. The method of claim 3, wherein the disassembly structural attribute data among the structure disassembly assessment data comprises
pre-disjoint component number data that indicate a number of components that must be removed in order to extract the coupling element of the corresponding structure,
disposition state data that indicate a degree of interference of neighboring structures or components for extracting the coupling element of the corresponding structure,
coupling element number data that indicate a number of coupling elements of the corresponding structure,
connected component number data that indicate a number of structures or individual components that are connected to the corresponding structure, and
coupling point number data that data indicate a number of coupling points of the corresponding structure.

9. The method of claim 8, wherein the determining a disassembly assessment index determines is the disassembly assessment index by endowing weights in a sequence of the disposition state data, the pre-disjoint component number data, the coupling point number data, the connected component number data, and the coupling element number data.

10. The method of claim 2, wherein the component disassembly assessment data comprise accessibility data that has information on ease of approaching a coupling element of a corresponding component, disassembly force transmissibility data that has information on ease of transmitting disassembling force to the coupling element of the corresponding component, and disassembly structural attribute data that has information on the coupling element itself of the corresponding component.

11. The method claim 10, wherein the accessibility data of the component disassembly assessment data comprise at least one of
disposition state data that indicate a degree of stability of disposition of the corresponding component,
approaching direction change number data that indicate a number of changes of direction of approach to the coupling element of the corresponding component,
coupling portion exposure data that indicate a degree of interference by other components while approaching the corresponding component coupling portion, and
state maintenance data that data indicate interference by other components and a necessity of state maintenance of the other components while approaching the coupling element of the corresponding component.

12. The method of claim 11, wherein the determining a disassembly assessment index determines the disassembly assessment index by endowing weights in a sequence of the coupling portion exposure data, the approaching direction change number data, the state maintenance data, and the disposition state data among the accessibility data.

13. The method of claim 10, wherein the disassembly force transmissibility data among the component disassembly assessment data comprise at least one of
fixing state data that indicate a necessity of holding the corresponding component while disassembling the corresponding component,
working space size data that indicate a size of a working space in which an operation to disassemble the coupling element of the corresponding component is performed,
disassembling force data that indicate an amplitude of a required disassembling force for disassembling the coupling element of the corresponding component, and
holding ease data that indicate ease of holding the coupling element of the corresponding component.

14. The method of claim 13, wherein the determining a disassembly assessment index determines the disassembly assessment index by endowing weights in a sequence of the fixing state data, the disassembling force data, the working space size data, and the holding ease data.

15. The method of claim 10, wherein the disassembly structural attribute data among the structure disassembly assessment data comprise
pre-disjoint component number data that indicate a number of components that must be previously removed in order to disassemble the coupling element of the corresponding component,
disposition state data that indicate a degree of interference of neighboring structures or components for disassembling the coupling element of the corresponding component,
coupling element number data that indicate a number of coupling elements of the corresponding component,
connected component number data that indicate a number of structures or components that are connected to the corresponding component, and
coupling point number data that indicate a number of coupling points of the corresponding component.

16. The method of claim 15, wherein the determining a disassembly assessment index determines the disassembly assessment index by endowing weights in a sequence of the disposition state data, the pre-disjoint component number data, the coupling point number data, the coupling element number data, and the connected component number data.
